(19) United States
(12) Patent Application Publication
(10) Pub. No.: US 2011/0041884 A1
(43) Pub. Date: Feb. 24, 2011

(54) Crutch Apparatus

(76) Inventors: Mark E. Hanna, Fremont, MI (US); Alastair J. Brown, Walker, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/856,930

(22) Filed: Aug. 16, 2010

Related U.S. Application Data
(60) Provisional application No. 61/235,119, filed on Aug. 19, 2009.

(51) Int. Cl. A61H 3/02

(52) U.S. Cl. 135/66

(57) ABSTRACT

A crutch apparatus to assist a person with ambulation comprises a vertical stabilizer including a main shaft, an underarm body, a bracket, a handle, and also includes an adjustable foot telescopingly engaging the floor. The bracket includes a first section engaging the main shaft, a second section extending parallel the first section, and a brace extending between the first and second sections. A cradle assembly includes a cradle on the second section for receiving a person's knee adjustable for height and lower leg engaging the floor at bottom of the second section. The vertical stabilizer and cradle are adjustable for different height persons, and are also adjustable to change a tilt of the apparatus relative to the person, whereby the person can adjust the tilt to a most stable condition for use.

### CROSS-REFERENCE TO RELATED APPLICATIONS

This application claims benefit under 35 U.S.C. §119(e) of provisional application Ser. No. 61/235,119, filed Aug. 19, 2009, entitled CRUTCH ACCESSORY, the entire contents of which are incorporated herein by reference.

### BACKGROUND OF THE INVENTION

The present invention relates to a crutch apparatus for use by an individual with a lower leg, ankle, foot, or toe injury.

An individual with a severe lower leg injury (including ankle, foot, and/or toe) is typically casted and walks with extreme difficulty, frequently requiring the use of crutches. For ankles, the injury itself is often very painful when any weight at all is placed on it during ambulation, and it is difficult to utilize crutches and hold one's leg bent at the knee to elevate the ankle to prevent pain during movement. Although some devices have been made for strapping directly to one's leg and knee to provide a solution for the discomfort suffered by an individual with an ankle injury, such devices are limited to their specific use and are somewhat difficult for a patient to attach and use. Further, many such devices are overly expensive, complex, neither flexible nor adaptable to particular patient's needs or preferences, and are not adjustable.

### SUMMARY OF THE INVENTION

The present system provides a crutch apparatus with a cradle for receiving a person's knee and section of his/her lower leg adjacent to the knee. The cradle is supported by a post and connected to a crutch-like vertical stabilizer by a bracket, the cradle being adjustable to a height that allows the user to ambulate using the crutch apparatus, with his/her knee supported in the cradle in an elevated position.

In a narrower aspect, the bracket and/or stabilizer is adjustable to a plurality of positive discrete positions, so that a combination of the vertical stabilizer and adjustable post position the cradle and upper end of the stabilizer at a desired lateral tilt for optimal side-to-side balance by the person.

In a narrower aspect, when in a sitting position, the individual seated can utilize the crutch apparatus as a stand for elevating the lower leg and ankle when seated, or can even actually sit on the accessory for temporary support.

In another aspect of the present invention, a crutch apparatus is provided to assist a person with ambulation. The apparatus comprises a vertical stabilizer including a main shaft, an underarm body, a bracket, and a handle. The bracket includes a first section engaging the main shaft, a second section extending parallel to the first section, and a brace extending between the first and second sections. A cradle is positioned on the second section for receiving and supporting a person's knee and lower leg adjacent to the knee. An adjustable floor-engaging member telescopingly engages a bottom of the first or second section, and is adjustable to change a tilt of the cradle and stabilizer relative to the person, whereby the person can adjust the tilt to a most stable condition for use.

In another aspect of the present invention, a crutch apparatus includes a cradle for supporting a person's leg and ankle, a bracket supporting the cradle, and a vertical stabilizer that both facilitates moving the cradle when taking a step and also supports the cradle on a floor surface to support the weight of a person. The cradle includes a body that, when in a use position, defines an upwardly-concave cross section in a lateral direction and that also defines a constant cross section in a front-to-rear direction.

These and other features, objects and advantages of the present invention will become apparent upon reading the following description thereof together with reference to the accompanying drawings.

### BRIEF DESCRIPTION OF THE DRAWINGS

FIGS. 1-2 are front and side views of a person using a crutch apparatus embodying the present invention.

FIGS. 3-4 are front and side views of the apparatus of FIG. 1; and

FIG. 5 is an exploded rear view of FIG. 3.

FIGS. 6-8 are orthogonal views of the bracket (also called a “base” or “brace” herein).

FIGS. 9-10 are fragmentary elevational and enlarged views of the adjustable foot on the adjustable post of the bracket in FIG. 3.

FIGS. 11-12 are side views of the crutch-attaching bracket, with the adjustable post being adjusted to different positions to cause different side-to-side lateral tilts with respect to a person using the device.

FIG. 13 is a perspective view of the handle in FIG. 3.

FIG. 14 is a top view of FIG. 3 showing the handle, bracket and cradle.

FIGS. 15-16 are perspective and cross sectional views of the underarm support member (also called a “body”).

FIGS. 17-18 are side and side/cross sectional views of the cradle of FIG. 3.

FIGS. 19-20 are side and top views of a modified bracket similar to the bracket of FIGS. 6-8.

FIG. 21 is an exploded perspective view of a modified cradle not totally dissimilar to FIG. 17, and

FIG. 22 is an enlarged view of an attachment system for attaching the mesh carrier to the perimeter support in FIG. 21.

FIG. 23 is a front view showing reversibility of the present apparatus of FIG. 1 for right leg and left leg use.

FIG. 24 is a cross sectional view of a modified rock-forward foot for use on the adjustable post under the cradle.

FIG. 25 is a side view of a person using the present apparatus to elevate their leg while seated.

FIG. 26 is a side view of the apparatus of FIG. 1 including a carry pouch on the bracket.

### DETAILED DESCRIPTION OF THE PREFERRED EMBODIMENT

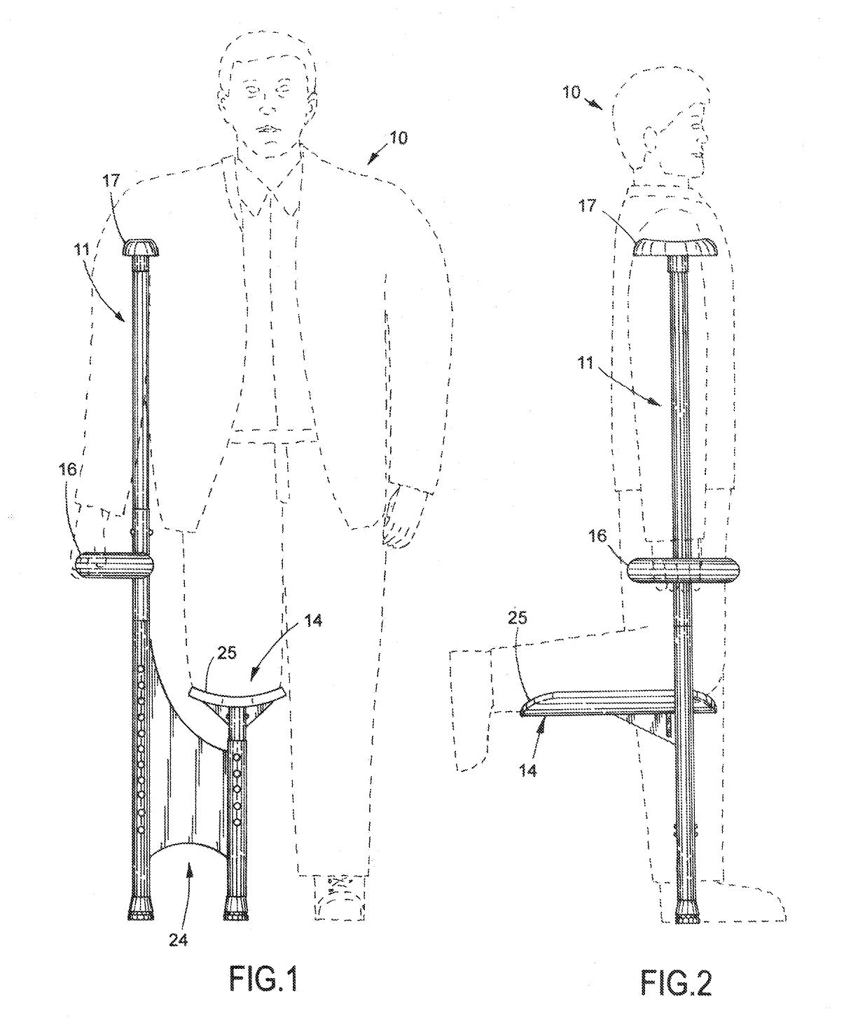

FIGS. 1-2 illustrate an individual 10 with an ankle injury in his right leg and utilizing the present crutch apparatus for ambulation. The present apparatus includes a cradle assembly 14 for supporting a person's knee and lower leg, a vertical stabilizer 11 positioned between the person's arm and body (and near their underarm), and a bracket 24 that supports the cradle assembly 14 on the vertical stabilizer 11. As seen in FIG. 1, the individual 10 can rest his lower leg on the cradle assembly 14, keeping his lower leg/ankle/foot elevated while moving. The apparatus allows an individual to take steps with their weight rested on the cradle and while maintaining stability, and also allow the person to swing the apparatus forward when their other leg is supporting their weight. Notably, it is not necessary to use two crutches with the present apparatus for good balance and movement, as discussed below.

Briefly stated, the cradle assembly 14 is load bearing and also elevates the foot. A rubber foot on the post under the cradle is fixed and provides non-slip engagement with a floor surface. A post on a bottom of the vertical stabilizer 11 (or on the post under the cradle assembly) is height adjustable, allowing the side-to-side tilt of the apparatus to be adjusted for user preference and optimal balance. Notably, the illustrated cradle assembly 14 can be adjusted for use to support a person's right or left lower leg.

The vertical stabilizer 11 is substantially non-load bearing, and is meant to vertically stabilize the person's knee and side. As such, we consider the present apparatus to be different than a traditional crutch, which is one reason why we used a different name herein. The stabilizer 11 has an adjustable post/foot for adjustably tilting the crutch apparatus towards the person's body for comfort and stability. Vertical stabilizer 11 includes a handle, under-arm body portion, and is adjustable for the user's overall height. Notably, our testing shows that a main purpose of the vertical stabilizer 11 is to hold the cradle assembly 14 upright, and to allow a person to easily carry and move the cradle assembly forward when taking a step (i.e. walking). The vertical stabilizer includes an underarm body 17 with curved side surfaces so that it that fits generally between a person's arm and body in a position generally under a person's armpit. However, the underarm body 17 is not intended to press against an armpit. Instead, the underarm body 17 includes a concave inner surface and a concave outer surface that matably engage a person's upper torso and arm. Thus, the body of the vertical stabilizer 11 allows the person to keep the cradle upright and to move the cradle with the person when taking steps by action of the person's torso and arm, but the vertical stabilizer does not normally carry any vertical load. Instead, the person's weight tends to rest on the cradle subassembly.

The bracket 24 attaches the cradle assembly 14 to the vertical stabilizer 11. It is made for strength and durability, and as illustrated is a single-piece extrusion. More specifically, the illustrated vertical stabilizer (FIG. 5) includes a tubular main shaft 15, a handle 16, and the underarm body 17. The handle 16 includes a sleeve 18 engaging the main shaft 15, and a locking mechanism such as an internal resilient-metal spring clip 18′ (or clamp) to fix its position on the main shaft 15. The sleeve 18 can be vertically adjustable on the main shaft 15 if desired. The handle 16 also includes a hand grip 19 (such as the loop-shaped grip shown or a post grip). The bracket 24 includes a tube section 20 telescopingly engaging the main shaft 15 for gross vertical adjustment, and an adjustable tubular post 21 that adjustably engages a lower end of the tube section 20. The post 21 has a rubber boot on its lower end for non-slip engagement with a floor surface. The main shaft 15 includes a spring clip for selectively engaging one or a plurality of holes 21A in the tube section 20 to set an adjusted height. The illustrated underarm body 17 is an injection molded part including an underarm portion 22 for fitting comfortably against a person's side and against and inside of their arm. It includes an integrally-molded tubular connector 23 for telescopingly engaging a top of the main shaft 15. Ribs 22′ stabilize the tubular connector 23 on the underarm portion 22. (See FIG. 16.) A snap spring on the main shaft 15 retains the tubular connector 23 on the main shaft 15 in a vertically-locked position.

A cushioned layer 41 (such as a foam layer, see dashed lines in FIG. 16) can be bonded or otherwise attached (or molded onto) to the underarm portion 22 for comfort and aesthetics. However, it is contemplated that the underarm portion 22 can be molded with a top wall portion having enough resiliency and flex to comfortably support a user during use. For example, it is contemplated that the underarm portion 22 could be relatively thin and/or have slots and transverse strips providing a comfortable flexure. It is noted that the underarm body 17 can be metal or plastic, and if plastic, preferably has a relatively constant thickness to facilitate a molding process. Ribs 22′ and/or gussets are used as necessary to support the tubular connector post 23.

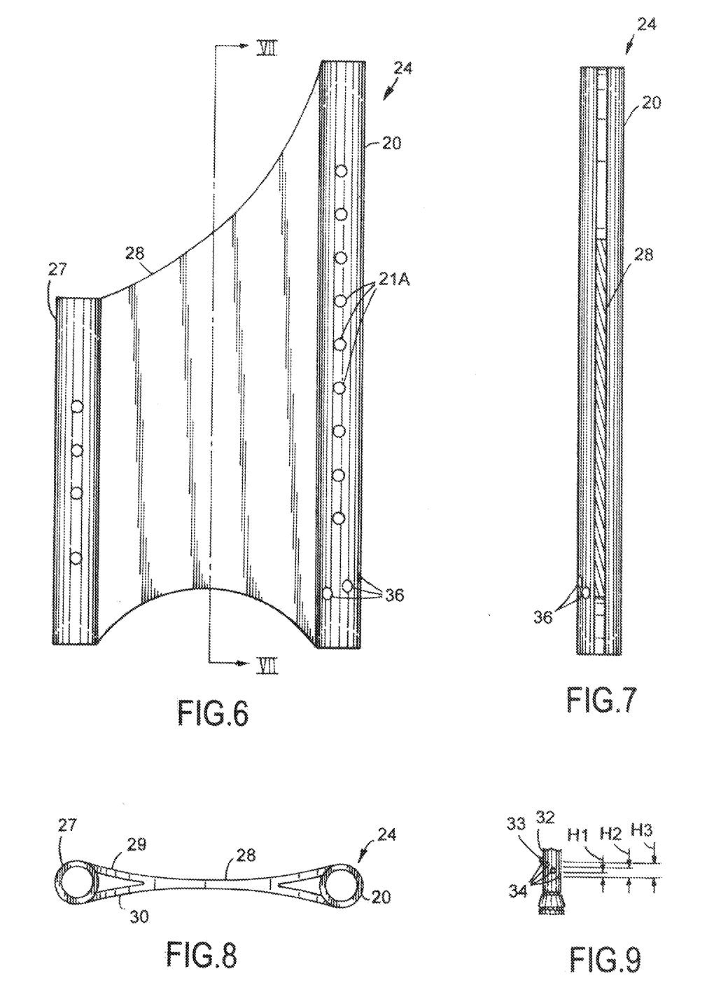

The bracket 24 includes a tube section 27 extending parallel its other tube section 20 (though slightly shorter in length), and a tube-to-tube stabilizer member 28 (also called a “brace”). The illustrated stabilizer member 28 (FIGS. 6-8) is a unitary single-piece extrusion having first and second arcuately-shaped panel-like sections 29 and 30 integrally connected at their middle along a vertical line, with spaced-apart edges extending from the panel-like sections 29 and 30 to opposite sides of the tube section 20 and to opposite sides of the tube section 27 in a manner providing good torsion strength. It is contemplated that the tube sections 20 and 27 can be integrally formed as part of the extrusion or attached separately to the panel-like sections 29 and 30 (such as by welding). It is contemplated that the bracket 24 will be an extrusion, but it is noted that it could be made in a variety of different ways, such as a welded assembly of two separately-formed arcuate panels, or a casting, or a molding. It is also contemplated that it can be made of metal, plastic, reinforced plastic, wood, or a composite. It is also contemplated that bracket 24 could be modified, such as by replacing the two panel-like sections 29 and 30 with a single panel 29A made sufficiently stiff for stable interconnection of the tube sections 20 and 27. (See bracket 24A in FIGS. 19-20.)

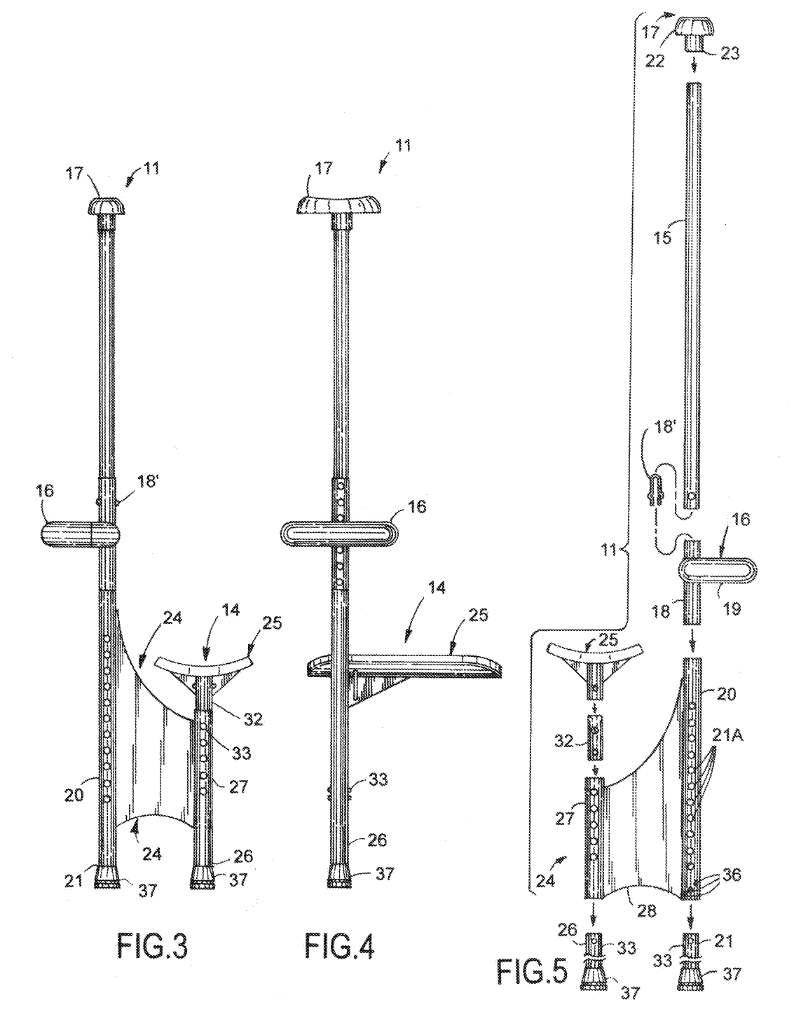

The knee cradle assembly 14 includes a knee cradle 25 with a down post 32 that telescopingly engages the tube section 27 and includes an internal spring clip 33 (FIG. 3) that lockingly engages a selected one of the holes 34 in the tube section 27 for gross height adjustment. The adjustable post 26 telescopingly engages a bottom of the tube section 27, and a second internal spring clip 35 engages a selected hole 36 in the tube section 27. A rubber foot 37 engages a bottom end of the post 26 for non-slip engagement with a floor surface. (A similar rubber foot 37 is used on adjustable tubular post 21.)

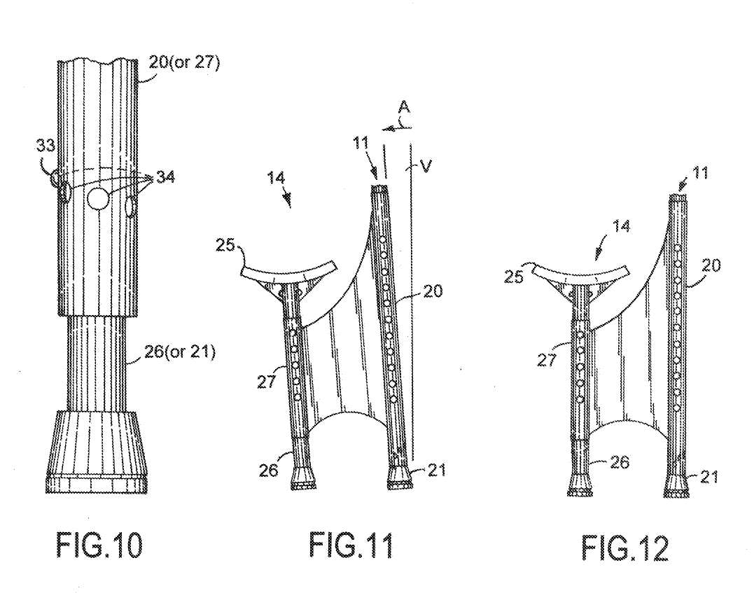

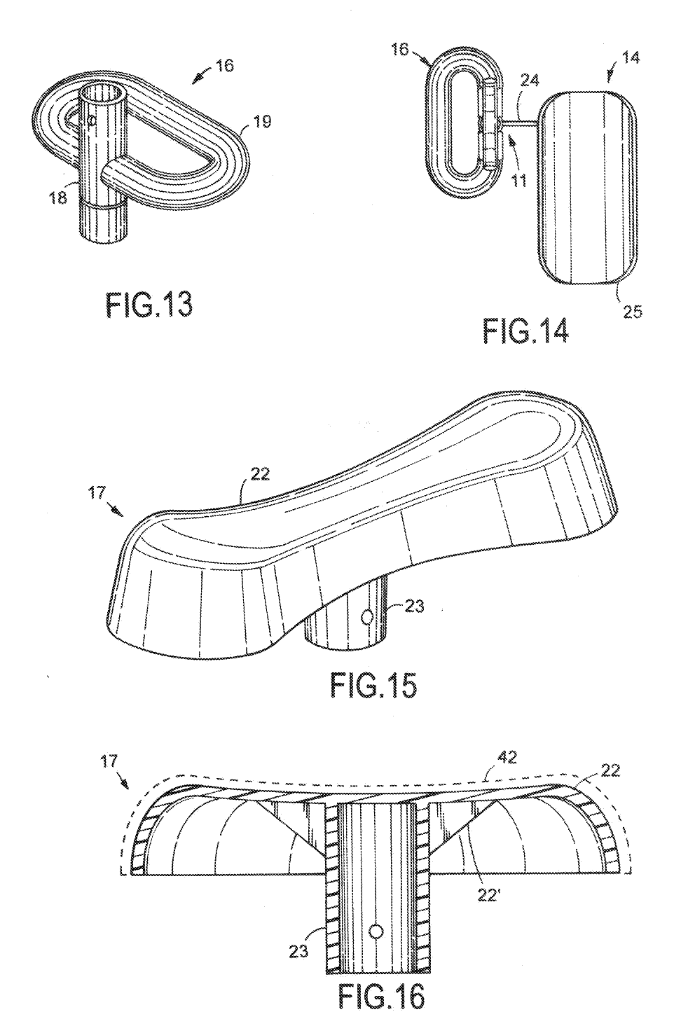

The holes 36 (FIGS. 9-12) are located at a bottom of the tube section 20 (though theoretically they also could be located on the tube section 27). The holes 36 are circumferentially positioned around the tube section 20 to allow a small incremental height adjustment, such as a ⅛″ incremental change in height for each 70 degrees of rotation. This contrasts to the holes 21A on the tubular main shaft 15 (and the holes along most of the tube section 20) which are spaced ¾″ to 1″ apart for a much larger incremental change in height adjustment to the vertical stabilizer 11. By rotating the tube section 20 to selectively engage different holes 21A, a relative length of the tube section 20 can be changed at small increments. This allows the lateral tilt (see tilts “A” and “B” in FIGS. 11-12) of the knee cradle 25 and vertical stabilizer 11 to be adjusted relative to a vertical line “V” so that the apparatus leans slightly toward the person using the apparatus. Our testing shows that this lateral tilt can be important in providing a crutch that is stable during use and that feels comfortable to the user. Notably, the holes 36 are about ¼″ diameter, such that the holes 36 cannot be located vertically, one above the other, without one hole overlapping onto the next. The illustrated holes 36 (FIGS. 9-10) are spaced around a circumference of the tube section 30 so that they do not overlap, each being at an increased height of about ⅛″ above the previous hole, so that they provide fine height adjustments of H1, H2 or H3. The illustrated holes 36 are positioned at about 70 degrees from each other around the tube, while avoiding the ends of the panel-like sections 29 and 30. This allows the spring clip to engage the holes 36 while still being accessible for release and adjustment. It is contemplated that the circumferentially-positioned holes could be replace with a different adjustment mechanism, such as a threaded member or fastener-fixed clamp.

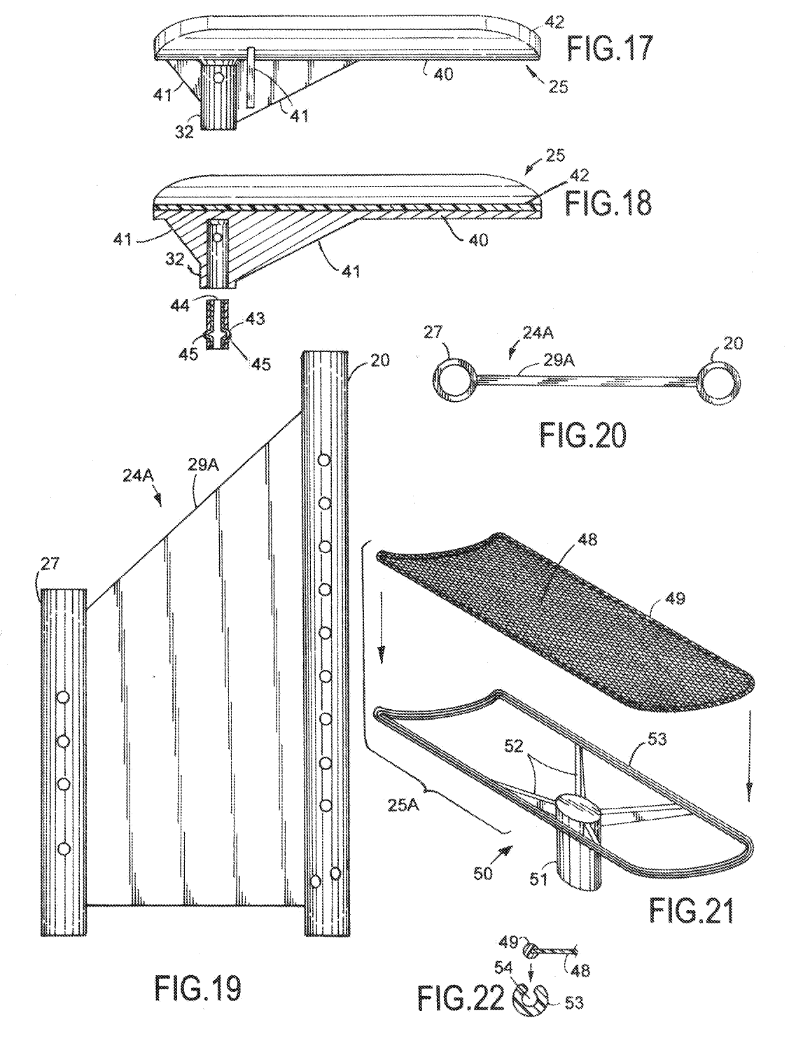

The knee cradle 25 (FIGS. 17-18) includes a curved pan or knee-supporting body 40, the integrally-formed stem or down post 32, ribs 41 and gussets as needed to stabilize the down post 32 on the body 40. As illustrated, a cushioned layer 42 is adhered to (or molded onto or otherwise secured to) the body 40. The down post 32 is hollow and includes a spring clip 43 with resilient portion 44 and protrusions 45 for engaging the selected holes in the tube section 27. The knee-supporting body 40 defines a recess for receiving a person's knee and lower leg. In a lateral direction, the body 40 is about 5-6 inches wide and defines an upwardly concave shape, and in a fore-aft direction it is about 10-14 inches long and defines a constant/linear cross section. The down post 32 is located toward a forward end of the knee cradle 25, such as 3-4 inches short of its forward edge.

It is contemplated that the knee cradle 25 can be replaced with a variety of different modules having different shapes, different constructions, different appearances, and even different functions. In one example, a modified cradle 25A (FIGS. 21-22) includes a tensioned mesh 48 with molded perimeter strip 49, and a perimeter support 50 with tube section 51 and radial ribs 52 that support a ring-shaped hoop 53 with retaining groove 54. The groove 54 and strip 49 are shaped so that the strip 49 can be zipped into or snapped into the groove 54, in an assembly process much like the operation of a zipper or the closing of a zip-lock bag. Once assembled, the mesh 48 and support 50 combine to provide a flexible cushioned hammock-like support that replaces the body 40 and cushioned layer 42, with the tube section 51 engaging a top of the tube section 27 on the bracket 24. Further, this embodiment provides a very attractive and sophisticated appearance which many people like. For example, it could be made to match an office chair, such as the well known Aeron™ chair made by Herman Miller, and it could include similar attachment structure of the mesh sheet to the perimeter support.

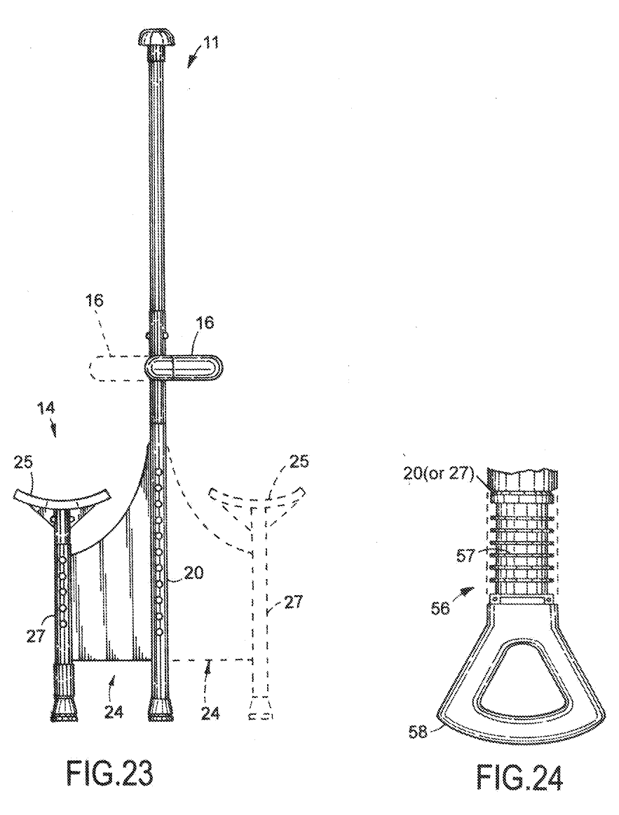

It is noted that the tube section 27 of the present bracket 24 include opposing holes, such that it is rotatable 180 degrees about the mating main shaft 15 (FIG. 23). This allows the cradle assembly 14 to be reversed for a person having an injured right lower-leg/ankle or having an injured left lower-leg/ankle. It is noted that the holes in the tube section 27 are positioned on opposite sides of the tube section 27 so that the spring clip will interlockingly engage them for secure fixed attachment, regardless of the right or left position.

It is contemplated that various floor-engaging feet can be used with the present apparatus. FIG. 5 discloses a common sock-like, rubber foot 37 telescoped onto and friction fit onto a bottom of the adjustable tubular post 21 (and post 26). FIG. 24 discloses a foot 56 having a frictional tube-engaging stem 57 and an arcuate bottom surface 58 for rolling engagement with a floor surface as the user moves forward, the foot 56, which allows the foot to remain in contact with the floor surface during a longer portion of the user's step. The arcuate bottom surface 58 also avoids a “bump” or other vertical movement as the user moves forward. It is contemplated that other floor-engaging components can also be used. It is noted that the present apparatus is modular, and able to mate with different custom-manufactured components if the user so desires.

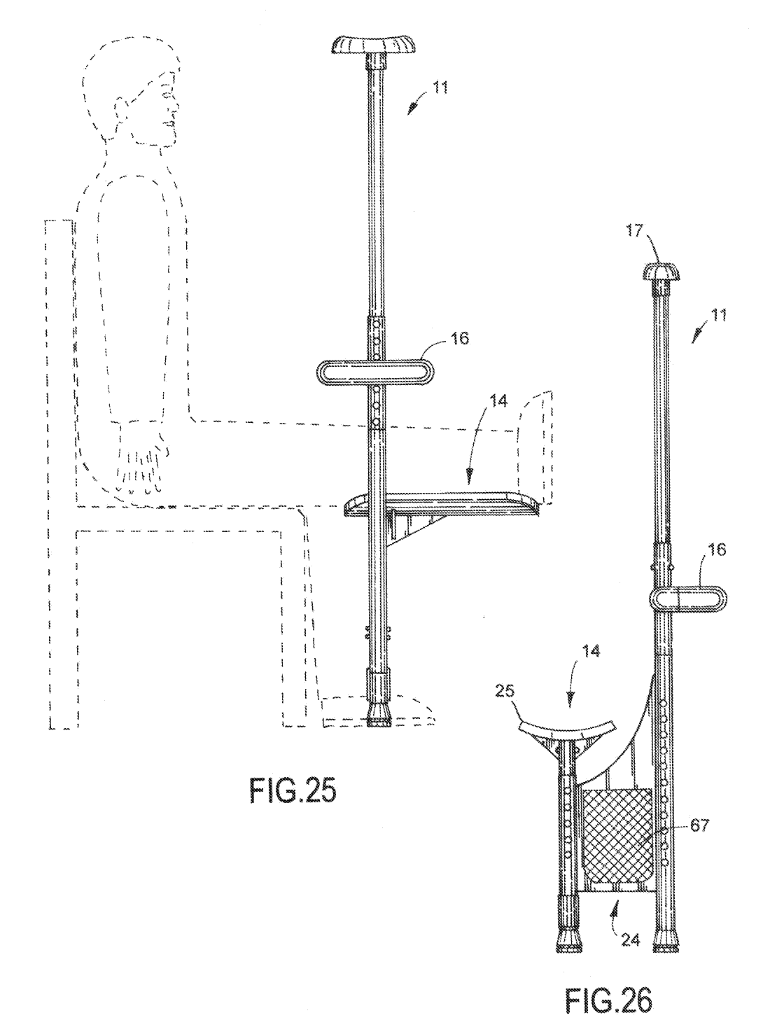

It is contemplated that the present apparatus with vertical stabilizer 11 and cradle assembly 14 can provide multi-functional uses to a person. For example, the person may use the vertical stabilizer 11 and cradle assembly 14 to hold up their injured leg at a raised elevation while seated on a separate chair or seat (FIG. 25). The present system is sufficiently stable and padded such that it is contemplated that a user could even sit on it with their buttocks resting on the knee cradle 25, and with their legs spaced apart and resting on a floor for stability.

It is contemplated that one or more of the above-described components can be manufactured as interconnectable separate components, with or without telescoping adjustability, or that the assembled apparatus can be made with fewer parts (i.e. with several components integrated into single parts as manufactured). For example, vertical stabilizer 11 and/or cradle assembly 14 can each be one piece, two pieces, or multiple interconnectable pieces. Also, the vertical stabilizer 11 and/or cradle assembly 14 can each be vertically adjustable, or only one made to be adjustable, or made as a non-adjustable (customized) crutch apparatus. Further, various telescopingly-engaging adjustable tube sections can be connected to the knee cradle 25, handle 16, body 17, adjustable tubular post 21, and/or bracket 24 in different ways, such as by clamps, bolt-on brackets, and the like. Further, it is contemplated that the present accessory apparatus can include additional secondary accessories, such as a closeable or mesh carry pouch 67 (FIG. 26) on the main shaft 15 (e.g. under the handle 16) or attached to a side of the bracket 24.

It will become apparent to those skilled in the art that various modifications to the preferred embodiment of the invention as described herein can be made without departing from the spirit or scope of the invention as defined by the appended claims.

The invention claimed is:

1. A crutch apparatus comprising:
a cradle shaped to receive a person's knee and lower leg adjacent the knee;
a crutch-like vertical stabilizer extending parallel the post; and
a bracket connecting the cradle and stabilizer;
wherein at least one of the cradle, bracket and stabilizer are adjustable to change lateral tilt of the crutch apparatus relative to a standing user for side-to-side balance and user preference.

2. The crutch apparatus defined in claim 1, wherein the stabilizer is adjustable to a plurality of positive discrete vertical positions of less than ¼″ apart, so that a combination of the vertical stabilizer and cradle position the cradle and upper end of the stabilizer at a desired lateral tilt relative to a person using the apparatus for optimal side-to-side balance by the person.

3. A crutch apparatus comprising:
a cradle for receiving and supporting a person's knee and lower leg adjacent the knee;
a bracket coupled to said cradle;
a vertical stabilizer for fitting adjacent the person's side and for lifting the cradle when taking a step; and
an adjustable post coupled to one of the stabilizer, the bracket and the cradle, the post being adjustable to a selected height which allows the user to ambulate using the apparatus with the knee supported by the cradle.

4. The crutch apparatus defined in claim 3 wherein the adjustable post includes a pair of tubes telescopically coupled together.

5. The crutch apparatus defined in claim 3, including stabilizer includes a main post attached to the bracket and extending vertically on one side of the bracket, the cradle being on an opposite side of the bracket.

6. The crutch apparatus defined in claim 3, wherein the bracket includes a first tubular section slidably engaging a main post on the vertical stabilizer and including a clip for fixing a selected position.

7. The crutch apparatus defined in claim 6, wherein the bracket includes a second tubular section engaging the adjustable post.

8. The crutch apparatus defined in claim 7, wherein the first tubular section includes a tube on the bracket that extends parallel the second tubular section.

9. The crutch apparatus defined in claim 3, wherein the adjustable post includes an adjustment mechanism for adjusting at increments of less than ¼″ which allows adjusting a lateral tilt of the apparatus toward the person.

10. The crutch apparatus defined in claim 9, wherein the adjustable post is adjustable in increments of about ⅛″ or less.

11. The crutch apparatus defined in claim 3, wherein the adjustable post includes a floor-engaging member, a post-forming tubular section, and an adjustment mechanism adjustably connecting the floor-engaging member and post-forming tubular section, the adjustment mechanism including a plurality of circumferentially spaced holes at different heights, and a clip in one of the floor-engaging member and the tubular section for selectively engaging the circumferentially spaced holes.

12. The crutch apparatus defined in claim 3, wherein the cradle is elongated and has concave shape in transverse direction and further the adjustable post is spaced from a longitudinal center of the cradle toward a front of the cradle.

13. The crutch apparatus defined in claim 3, wherein the cradle has a stiff perimeter and a flexible hammock-like region within the perimeter that is supported by the perimeter.

14. The crutch apparatus defined in claim 3, wherein the cradle is reversible on the bracket for use with an injured right leg or injured left leg.

15. A crutch apparatus to assist a person with ambulation, comprising:
a vertical stabilizer including a main shaft, an underarm body, a bracket, a handle, and an adjustable floor-engaging member telescopingly engaging a bottom of the first section; the bracket engaging the main shaft and the stabilizer;
a cradle assembly;
a bracket extending between the vertical stabilizer and the cradle assembly and spacing same apart; and
the cradle assembly being supported on the second section for receiving and supporting a person's knee and lower leg adjacent the knee and also including a lower leg engaging the floor.

16. The crutch apparatus defined in claim 15, wherein the bracket includes a first section that is tubular and engages the vertical stabilizer.

17. The crutch apparatus defined in claim 16, wherein the bracket includes a second section that is tubular and engages the cradle assembly.

18. The crutch apparatus defined in claim 15, wherein the bracket vertically adjustably engages the main shaft.

19. A crutch apparatus to assist a person with ambulation, comprising:
a vertical stabilizer including a main shaft, an underarm body, and a handle;
a cradle assembly;
a bracket including a first section engaging the main shaft, a second section engaging the cradle assembly extending parallel the first section, and a brace extending between the first and second sections;
the cradle assembly on the second section for receiving and supporting a person's knee and lower leg adjacent the knee; and
an adjustable floor-engaging member telescopingly engaging a bottom of the first section;
the vertical stabilizer and floor-engaging member being adjustable to change a height and tilt of the underarm stabilizer and cradle assembly, whereby the person can adjust the height and/or tilt of the crutch apparatus to a most stable condition for use.

20. The crutch apparatus defined in claim 19, wherein the handle adjustably engages the main shaft for height adjustment.

21. The crutch apparatus defined in claim 19, wherein the cradle assembly includes an integrally molded part including a stiff perimeter and a flexible apertured hammock-like region extending within the stiff perimeter.

22. A crutch apparatus to assist a person with ambulation, comprising:
an underarm vertical stabilizer; and
a cradle assembly including a leg-supporting cradle, a bracket attaching the cradle to the underarm vertical stabilizer, the cradle being shape to receive and support a person's knee and lower leg adjacent the knee, and including a floor-engaging post supporting the cradle; the cradle, when in a use position, defining an upwardly-concave cross section in a lateral direction and also defines a constant cross section in a front-to-rear direction.
